(19) United States
(12) Patent Application Publication
(10) Pub. No.: US 2004/0080117 A1
(43) Pub. Date: Apr. 29, 2004

(54) Encoder-equipped sealing device

(76) Inventor: Hironori Yamamoto, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 10/690,550

(22) Filed: Oct. 23, 2003

(30) Foreign Application Priority Data
Oct. 24, 2002 (JP) 2002-309088

(51) Int. Cl. F16J 15/32

(52) U.S. Cl. 277/549

(57) ABSTRACT

An encoder-equipped sealing device, that is, the sewing device that has the encoder incorporated therein is disclosed, which comprises a combination of seal elements (3, 2), each of which includes an annular metal core (31, 21) having a substantially L-shaped cross section and including a cylindrical portion (31a, 21a) and a flange portion (31b, 21b) provided on one end of the cylindrical portion (31a, 21a) and extending in the direction perpendicular to the direction in which the cylindrical portion (31a, 21a) extends. One seal element (3) of the two seal elements (3, 2) and the other seal element (2) are combined such that the space defined by the cylindrical portion (31a) and flange portion (31b) of the one seal element (3) and the space defined by the cylindrical portion (21a) and flange portion (21b) of the other seal element (2) face opposite each other, wherein the one seal element (3) further includes an elastic seal portion (6) provided on the flange portion (3b) and arranged in the space defined by the cylindrical portion (31a) and flange portion (31b), and the other seal element (2) further includes a magnet-based encoder (1) provided on the flange portion (21b). The one seal element (3) further includes a projecting portion (4a, 4b) on the end of the cylindrical portion (31a) on the side on which the flange portion (31b) is located and extending beyond the side of the flange portion (31b) opposite the side on which the seal portion (6) is located and in the direction in which the cylindrical portion (31a) extends.

### BACKGROUND

1. Field of the Invention

The present invention relates to an improvement to and/or in the encoder-equipped sealing device or sealing device that has a magnet-based encoder incorporated therein. More particularly, the present invention relates to such encoder-equipped sealing device that provides the capabilities for preventing the physical cohesion by the magnetic attraction from occurring between two or more units of the encoder-based sealing devices that are adjacent to each other, when those units are placed one over another so that those units are oriented in one particular direction.

2. Description of the Prior Art

The encoder (pulse coder) that is incorporated in the encoder-equipped sealing device that has been described above takes the form of a pulse generator ring that may be mounted on an automotive-vehicle in order to flexibly control the device that ensures that the vehicle can be running with safety and stability, such as the anti-lock braking system (ABS), traction control system (TCS) and stability control system (SCS). This encoder may be mounted on the hub flange in the suspension system together with a sensor, and is used to detect the number of revolutions for each of the vehicle wheels. The encoder is mounted on each of the four wheels, such as front, rear, right and left wheels, together with the sensor, and may be used to detect any difference in the number of revolutions between each of the wheels. In response to such difference, the encoder may turn the drive system or brake system on and off, thereby controlling the behavior of the vehicle to ensure that the vehicle can be running with stability and safety in case some emergency situations should occur.

Lubrication oils may leak from the bearing units on the automotive vehicle on which the safety running devices are install d as described above, and seals are required to avoid such leaks. Most of the sealing devices include integrated sealing and rotations detecting capabilities, and may be mounted on the gap or space that is available on the bearing units to meet such needs.

Typically, the sealing device that has been proposed for those recent years provides the rotations detecting function as well as encoder function, and has been used widely for the practical purposes.

The typical encoder-equipped sealing device that has been proposed and practically used will be described below by referring to FIG. 8.

Two units 41, 42 of the encoder-equipped sealing device are shown in FIG. 8, in which each of the units includes two seal elements 3, 2 combined together.

Specifically, the seal elements 3 includes a metal core 31 having a substantially L-shaped cross section wherein the metal core 31 has a cylindrical portion 31a and a flange portion 31b extending from one end of the cylindrical portion 31a in the direction perpendicular to the direction in which the cylindrical portion 31a extends. The seal element 3 further includes an elastic seal portion 6 on the flange portion 31b that is arranged in the space defined by the cylindrical portion 31a and flange portion 31b.

Similarly to the seal element 3, the seal element 2 also includes a metal core 21 having a substantially L-shaped cross section wherein the metal core 21 has a cylindrical portion 21a and a flange portion 21b extending from one end of the cylindrical portion 21a in the direction perpendicular to the direction in which the cylindrical portion 21a extends. The seal element 2 further includes a magnet-based encoder 1 that is arranged on the flange portion 21b.

It may be seen from FIG. 8 that the seal element 3 and seal element 2 are combined such that the space defined by the cylindrical portion 31a and flange portion 31b of the seal element 3 and the space defined by the cylindrical portion 21a and flange portion 21b of the seal element 2 face opposite each other.

The encoder-equipped sealing device that includes the combined seal elements 3 and 2 may be mounted on any area that need to be sealed, such as the appropriate area in the bearing unit on the automotive vehicle, and a sensor 11 shown by dot-dash lines in FIG. 2 may be mounted adjacently to the encoder 1 so that it can face opposite the encoder 1. It may be seen from FIG. 8 that in the unit 41, for example, the seal element 2 including the encoder 1 may be mounted on the rotational element, such as the inner or outer race of the bearing unit, wherein the pulses that are magnetically generated by the encoder 1 may be detected by the sensor 11.

All of the encoder-equipped sealing devices that have been described above may be maintained in storage before they are actually used, such as being mounted on the areas of the bearing units on the automotive vehicle that need to be sealed and each of the devices has the seal elements 2, 3 completely assembled together. In storage, the individual devices are maintained like a stack in which the devices are placed one over another such that they can be oriented in one particular direction, for the convenience of the easy handing by the appropriate handling tools. It may be seen from FIG. 8 that two units 41, 42 of the encoder-equipped sealing device, for example, are placed one over the other in the horizontal direction such that each encoder 1 is located on the right side, and is oriented in one particular direction.

The plural units of the encoder-equipped sealing device that are placed one over the other such that they are oriented in one particular direction, as shown in FIG. 8, are loaded in a magazine, and they are transported or storaged with being placed one over another such that they are oriented in one particular direction in the magazine. When they are actually used, they are removed from the respective magazines, and are mounted on the areas of the bearing unit that need to be sealed.

In the plural units of the encoder-equipped sealing device that are placed-one over the other so that they are oriented in one particular direction as shown in FIG. 8, the encoder 1 in the unit 41, for example, produces a strong magnetic force that attracts the metal core 31 on the seal element 3 in the other unit 42 magnetically. This may cause the cohesion by the magnetic attraction to occur between the seal element 2 in the unit 41 and the seal element 3 in the other unit 42.

When such cohesion occurs, the two units may attract each other magnetically within the magazine, from which it is difficult to remove the units by using ally appropriate fitting device that mounts the units on the area that needs to be sealed, such as the appropriate area in the bearing unit. This may cause the fitting device to become non-operational or may affect the working efficiency of the fitting device remarkably.

In another encoder-equipped sealing device that is proposed to address the problem described above, which is disclosed in Japanese patent application as published under No. 2001-141069, the seal portion is extended to provide a projection thereon. The object to provide this projection is to keep the two units of the encoder-equipped sealing device that are located adjacently to each other spaced away from each other. As this projection is formed as part of the elastic seal portion, the projection thus obtained is not sufficient to prevent the cohesion by the magnetic attraction that occurs between the two units.

### SUMMARY OF THE INVENTION

In order to eliminate the serious disadvantages and problems associated with the prior art encoder-equipped sealing devices described above, it is an object of the present invention to provide an encoder-equipped sealing device that has a simple construction and prevents the cohesion by the magnetic attraction that might otherwise occur between the two units of the encoder-equipped sealing device that are located adjacently to each other. That is to say, the object of the present invention is to provide encoder-equipped sealing devices by which the encoder-equipped sealing device can be removed from the magazine without being caught by each other, and then may be mounted securely on the area that needs to be sealed, such as the appropriate area in the bearing unit, even if the plural units of the encoder-equipped sealing device are placed one over the other such that they are oriented in one particular direction, as shown in FIG. 8, and loaded in a magazine.

The problems mentioned above may be solved by providing the encoder-equipped sealing device in accordance with the present invention that is constructed as described below.

The encoder-equipped sealing device that is proposed by the present invention comprises two seal elements 3, 2 combined together, wherein each of the elements 3, 2 includes a metal core 31, 32 having a substantially L-shaped cross section, each of the metal cores 31, 32 having a cylindrical portion 31a, 21a and a flange portion 31b, 21b provided on one end of the cylndical portion 31a, 21a and extending in the direction perpendicular to the direction in which the cylindrical portion 31a, 21a extends.

One seal element 3 and the other seal element 2 are combined together such that the space defined by the cylindrical portion 31a and flange portion 31b of the one seal element 3 and the space defined by the cylindrical portion 21a and flange portion 21b of the other seal element 2 face opposite each other.

The one seal element 3 further includes an elastic seal portion 6 on the flange portion 31b that is arranged in the space defined by its cylindrical portion 31a and flange portion 31b, and the other seal element 2 further includes a magnet-based encoder 1 on the flange portion 21b.

In the before described encoder-equipped sealing device, the present invention proposes the following seven embodiments.

In an encoder-equipped sealing device according to a first embodiment of the present invention, that is shown in FIG. 1, one seal element 3 further includes a projecting portion 4a on the end of the cylindrical portion 31a on the side on which the flange portion 31b is located, wherein the projecting portion 4a extends beyond the side of the flange portion 31b opposite the side on which the seal portion 6 is located and in the direction in which the cylindrical portion 31a extends.

In an encoder-equipped sealing device according to a second embodiment of the present invention, that is shown in FIG. 2 and a variation of the encoder-equipped sealing device according to the first embodiment, one seal element 3 includes an end 4b at the end of the cylindrical portion 31a on which the flange portion 31b is located, and wherein the said end 4b forming a projecting portion is formed by folding the base end of the flange portion 31b and the end of the cylindrical portion 31a thereby overlapping each other in the direction in which the cylindrical portion 31a extends.

In an encoder-equipped sealing device according to a third embodiment of the present invention, that is shown in FIG. 3, one seal element 3 further includes a projecting portion 4c extending beyond the side of the flange portion 31b opposite the side on which the seal portion 6 is located and extending in the direction in which the cylindrical portion 31a extends.

In an encoder-equipped sealing device according to a fourth embodiment of the present invention, that is shown in FIG. 5, the end portion 4d of the cylindrical portion 31a of the one seal element 3 extending toward the other seal element 2 is extending in the direction in which the cylindrical portion 31a extends and beyond the side of the other seal element 2 opposite the side on which the other seal element 2 faces opposite the one seal element 3.

In an encoder-equipped sealing device according to a fifth embodiment of the present invention, that is shown in FIG. 4, one seal element 3 further includes a recess 4f that is formed on the side of the flange portion 31b opposite the side on which the seal portion 6 is located, wherein the said recess 4f extends toward the side on which the seal portion 6 is located

In an encoder-equipped sealing device according to a sixth embodiment of the present invention, that is shown in FIG. 6, the encoder 1 is arranged on the side of the flange portion 21b of the other seal element 2 opposite the side on which the flange portion 21b faces opposite the one seal element 3, and wherein the flange portion 21b includes a projecting portion 4e that extends beyond the surface of the encoder 1 and in the direction in which the cylindrical portion 21a extends.

In an encoder-equipped sealing device according to a seventh embodiment of the present invention, that is shown in FIG. 7, one seal element 3 further includes an elastic lateral side portion 5 formed on the side of the flange portion 31b opposite the side on which the seal portion 6 is located, and wherein the elastic lateral side portion 5 has undulations 4g formed thereon

In any of the before described embodiments, the seal portion 6 may be formed from any elastic materials such as synthetic rubber, synthetic resin and the like, and the annular metal core 21, 31 may be formed from iron or stainless steel materials. The encoder 1 is a multi-pole magnet that may be formed like an annular magnet from a mixture composed of any elastic material such as synthetic rubber, synthetic resin or like and any ferromagnetic material such as ferrite, rare earth or like in powdery forms. The annular magnet has N polarities and S polarities magnetized alternately around the circumference. The before described seal portion, annular metal core, and encoder are known and used in the conventional encoder-equipped sealing device comprised by incorporating encoder and sealing elements combined together, and mounted on the bearing unit on the automotive vehicle's wheel.

The encoder-equipped sealing devices that have been described in connection with the before described embodiments are used together with a sensor that may be disposed adjacently to and opposite the encoder 1 so that it can detect the pulses that are generated magnetically by the encoder 1. The magnet-based encoder 1 that is located on the seal element mounted on the rotational element on the automotive vehicle are rotated as the rotational element rotates, and the pulses from the encoder 1 rotating as the before described are detected by the sensor. Thereby, the number of revolutions are detected by the sensor. It may be understood from the foregoing description that the encoder-equipped sealing device of the present invention has the encoder 1 incorporated therein.

In any of the first, second, third, fourth and sixth embodiments of the present invention, when the plural units of the encoder-equipped sealing device of the present invention are placed one over the other adjacently to each other so that they are oriented in one particular direction, for example, when two units 51, 52 of the encoder-equipped sealing device are placed one over the other adjacently to each other so that they are oriented in one particular direction as shown in FIG. 1, the two adjacent units 51 and 52 can be kept spaced away from each other by the cylindrical portion or flange portion of the metal core. This can keep the gap between the two adjacent units 51 and 52 constant, and the physical cohesion by the magnetic attraction that would occur between the two units 51 and 52 can thus be prevented effectively.

In the fifth embodiment, when the plural units of the encoder-equipped sealing device of the present invention are placed one over the other adjacently to each other so that they are oriented in one particular direction, for example, when two units 51, 52 of the encoder-equipped sealing device are placed one over the other adjacently to each other so that they are oriented in one particular direction as shown in FIG. 1, the area of contact between the encoder and the flange portion of the metal core can be kept as small as possible, and the physical cohesion by the magnetic attraction that would occur between the two units can thus be prevented effectively.

In the seventh embodiment, when the plural units of the encoder-equipped sealing device of the present invention are placed one over the other adjacently to each other so that they are oriented in one particular direction, for example, when two units 51, 52 of the encoder-equipped sealing device are placed one over the other adjacently to each other so that they are oriented ii one particular direction as shown in FIG. 1, the gap between the two adjacent units can be kept constant by the elastic lateral side portion 5 having the undulations 4g formed thereon, and the physical cohesion by the magnetic attraction that would occur between the two units can thus be prevented effectively.

It may be understood from the above description that when plural units of the encoder-equipped sealing device of the present invention are placed one over the other so that they are oriented in one particular direction as show in FIG. 1, the cohesion by the magnetic attraction that might otherwise occur between the adjacent units can be prevented effectively. So that, even if the plural units of the encoder-equipped sealing device are loaded in the magazine, with the units being placed one over the other so that they are oriented in one particular direction, the encoder-equipped sealing device can be removed from the magazine without being caught by each other, and can then be mounted securely onto the area that needs to be sealed, such as the appropriate area in the bearing unit.

That is to say, even if the plural units of the encoder-equipped sealing device are placed one over the other so that they are oriented in one particular direction, the encoder-equipped sealing device can be slided relative to the other without causing any problems. Also, either of the two units that are located adjacently can be moved away from the other without causing any problems, so that each of the encoder-equipped sealing devices can be handled after detaching each other. Thus, the encoder-equipped sealing device of the present invention can be slid smoothly out of the magazine equipped in the fitting tool, without causing any problems such as being caught or stuck. Thus, the encoder-equipped sealing device can be mounted-on the area that needs to be sealed, such as the appropriate area in the bearing unit, with the highest reliability.

### BRIEF DESCRIPTION OF DRAWINGS

FIG. 1 is a cross sectional view of the encoder-equipped sealing device in accordance with a first embodiment of the present invention, showing that two units; of the encoder-equipped sealing device, for example, are placed adjacently to each other in the horizontal direction so that they are oriented in one particular direction although some non-critical parts are not shown;

FIG. 2 is a cross sectional view of the encoder-equipped sealing device in accordance with a second embodiment of the present invention, with some non-critical parts not being shown;

FIG. 3 is a cross sectional view of the encoder-equipped sealing device in accordance with a third embodiment of the present invention, with some non-critical parts not being shown;

FIG. 4 is a cross sectional view of the encoder-equipped sealing device in accordance with a fifth embodiment of the present invention, with some non-critical parts not being shown;

FIG. 5 is a cross sectional view of the encoder-equipped sealing device in accordance with a fourth embodiment of the present invention, with some non-critical parts not being shown;

FIG. 6 is a cross sectional view of the encoder-equipped sealing device in accordance with a sixth embodiment of the present invention, with some non-critical parts not being shown;

FIG. 7 is a side elevation of the encoder-equipped sealing device in accordance with a seventh embodiment of the present invention, with some parts being shown in cross section; and

FIG. 8 is a cross sectional view of the encoder-equipped sealing device in accordance with the prior art, showing that two units of the encoder-equipped sealing device are placed adjacently to each other in the horizontal, direction so that they are oriented in one particular direction although some non-critical parts are not shown;

### DETAILED DESCRIPTION OF THE INVENTION

Several preferred embodiments of the present invention are now described below by referring to the accompanying drawings.

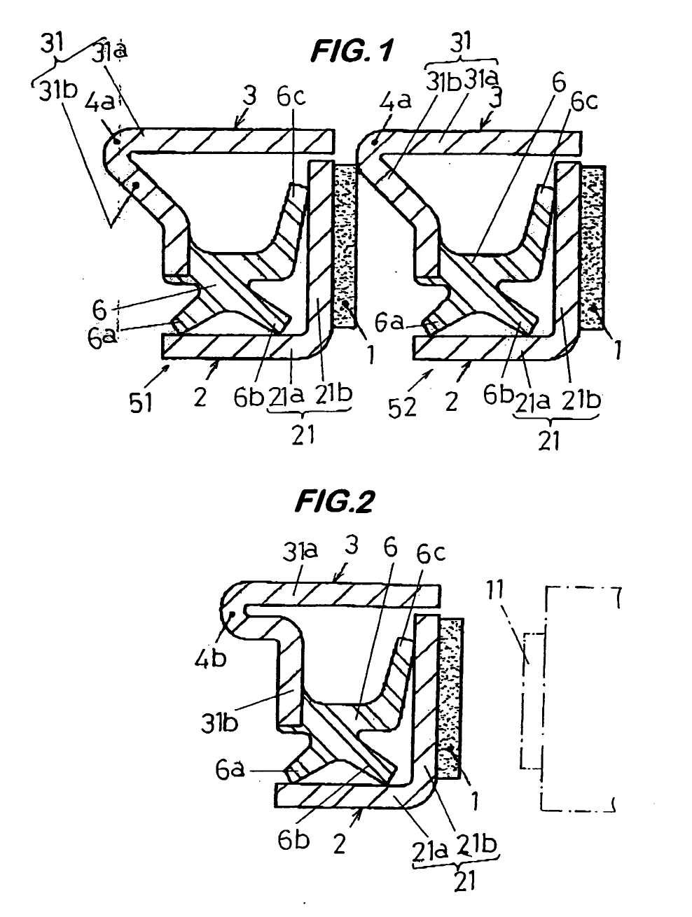

It should be noted that the encoder-equipped sealing device according to the prior art that has been described so far by referring to FIG. 8 and the encoder-equipped sealing device according to the various embodiments of the present invention that will be described below by referring to FIGS. 1 through 7 contain some common parts, elements or members. In the following description, those common parts, elements or members are given same reference numerals, and are not described to avoid the duplication.

Referring first to FIG. 1, the encoder-equipped sealing device according to a first embodiment of the present invention is described. In the encoder-equipped sealing devices 51 and 52, the seal element 3 includes a projecting portion 4a on the end of the cylindrical portion 31a on the side on which the flange portion 31b is located. The projecting portion 4a extends beyond the side of the flange portion 31b opposite the side on which the seal portion 6 is located and in the direction in which the cylindrical portion 31a extends. That is to say, the projecting portion 4a extends beyond the left side of the flange portion 31b in FIG. 1.

In the embodiment shown in FIG. 1, the end of the cylindrical portion 31a that is located on the left side and the base end of the flange portion 31b are formed in such a manner as to extend toward the left side. The before described portion extends toward the left side in FIG. 1 forms the projecting portion 4a.

Referring next to FIG. 2, the encoder-equipped sealing device according to a second embodiment of the present invention is described. This second embodiment is based on the inventive concept on which the first embodiment is based.

In the encoder-equipped sealing device shown in FIG. 2, the seal element 3 includes an end 4b at the end of the cylindrical portion 31a on which the flange portion 31b is located The end 4b forms a projecting portion as shown in FIG. 2. The end 4b is formed by folding the base end of the flange portion 31b and the end of the cylindrical portion 31a thereby overlapping each other in the direction in which the cylindrical portion 31a extends as shown in FIG. 2.

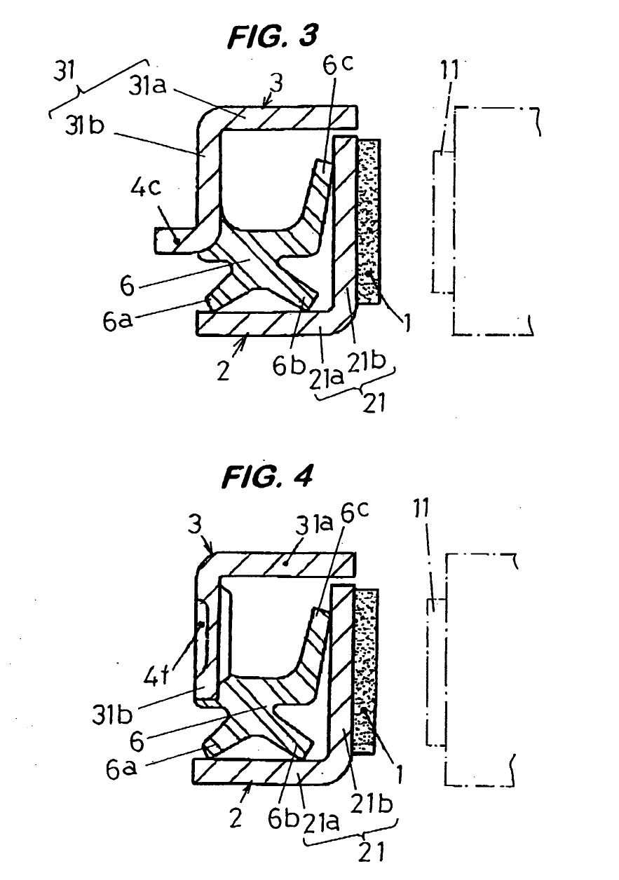

Referring next to FIG. 3, the encoder-equipped sealing device according to a third embodiment of the present invention is described.

In the encoder-equipped sealing device shown in FIG. 3, the seal element 3 includes a projecting portion 4c extending beyond the side of the flange portion 31b opposite the side on which the seal portion 6 is located and extending in the direction in which the cylindrical portion 31a extends. That is to say, the projecting portion 4c extending beyond the left side of the flange portion 31b in FIG. 3.

In the third embodiment shown in FIG. 3, the projecting portion 4c is formed by bending the end of the flange portion 31b toward the left side in FIG. 3. It should be noted that this embodiment may be varied such that the projecting portion 4c can be located on the middle portion of the flange portion 31b.

Referring next to FIG. 5, the encoder-equipped sealing device according to a fourth embodiment of the present invention is described.

In the encoder-equipped sealing device shown in FIG. 5, the end portion 4d of the cylindrical portion 31a of the seal element 3 extending toward the& other seal element 2 extends in the direction in which the cylindrical portion 31a extends. And the said end portion 4d further extends beyond the side of the other seal element 2 opposite the side on which the other seal element 2 faces opposite the seal element 3. That is to say, the end portion 4d of the cylindrical portion 31a of the seal element 3 extends beyond the right side of the seal element 2 in the direction in which the cylindrical portion 31a extends.

In the fourth embodiment shown in FIG. 5, an encoder 1 is arranged on the side (right side in FIG. 5) of the flange portion 21b opposite the side on which the flange portion 21b faces the seal element 3. As the end 4d of the cylindrical portion 31a of the seal element 3 extends beyond the side (right side in FIG. 5) of the seal element 2 opposite the side on which the seal element 2 faces the seal element 3, the end 4d extends beyond the right side of the encoder 1 in FIG. 5 and in the direction in which the cylindrical portion 31a extends.

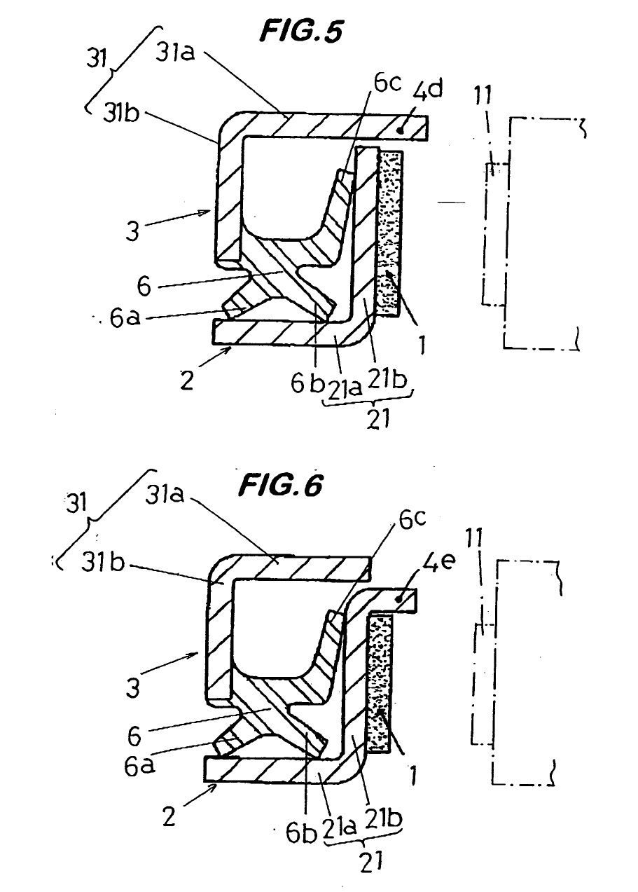

Referring next to FIG. 6, the encoder-equipped sealing device according to a sixth embodiment of the present invention is described.

In the encoder-equipped sealing device shown in FIG. 6, the encoder 1 is arranged on the side of the flange portion 21b of the seal element 2 opposite the side on which the flange portion 21b faces opposite the seal element 3. That is to say, the encoder 1 is disposed on the right side of the flange portion 21b of the seal element 2. And the flange portion 21b includes a projecting portion 4e that extends beyond the surface of the encoder 1 and in the direction in which the cylindrical portion 21a extends.

In the sixth embodiment shown in FIG. 6, the projecting portion 4e is formed by bending the end of the flange portion 21b, and the projecting portion 4e extends beyond the right side of the encoder 1 and in the direction in which the cylindrical portion 21a extends.

In any of the embodiments described above by referring to FIGS. 1, 2, 3, 5 and 6, when two units of the encoder-equipped sealing device as designated by 51, 52 are placed one over the other adjacently to each other in particular direction as shown in FIG. 1 so that those units are oriented in one particular direction, the projecting portion 4a, the end 4b forming the projecting portion, the projecting portion 4c, the end 4d and the projecting portion 4e can exist between the two adjacent units 51 and 52.

Those projecting portions and ends that exist between the two adjacent units 51 and 52 can prevent the encoder 1 in one unit and the flange portion 31b in the other unit from contacting each other over the wide area, as opposed to the case shown in FIG. 8.

Thus, the magnetic force produced from the encoder 1 in the unit 51 against the flange portion 31b in the unit 52 can be reduced greatly.

This can prevent the cohesion by the magnetic attraction from occurring between two adjacent units 51 and 52.

In particular, in each of the embodiments shown in FIGS. 5 and 6, the end 4d or projecting portion 4e in one unit can abut against the flange portion 31b in the other adjacent unit, which can prevent the encoder 1 in the unit 51 from contacting the flange portion 31b in the unit 52. Thus, those embodiments are very advantageous in that the cohesion by the magnetic attraction between the two adjacent units 51 and 52 can be prevented.

It should be noted that in each of the embodiments shown in FIGS. 1, 2 and 3, the area of contact between the encoder 1 in the unit 51 and the flange portion 31b in the unit 52 can be made as small as possible by modifying the size of the flange portions 21b, 31b as viewed vertically in the respective figures, the size of the encoder 1, the size of the projecting portion 4a, and the size of the end 4b forming the projecting portion, respectively.

In each of the embodiments shown in FIGS. 5 and 6, the respective end 4d and projecting portion 4e may be extended further toward the right side in FIGS. 5 and 6, respectively. In this way, the gap between the encoder 1 and the sensor 11 located adjacently to and opposite the encoder 1 can be covered like an umbrella by the end 4d and projecting portion 4e. Thus, the gap between the encoder 1 and sensor 11 can be protected from any foreign matter that might otherwise enter the gap.

In each of the embodiments described so far by referring to FIGS. 1, 2, 3, 5 and 6 the gap between the units 51 and 52 that are located adjacently to each other are determined by the presence of the projecting portion 4a, the end 4b forming the projecting portion, the projecting portion 4c, the end 4d, and the projecting portion 4e. Thus, those projecting portion 4a, etc., which are made of metal, can keep the gap between the adjacent units 51 and 52 as constant as it is originally designed.

Referring to FIG. 4, the encoder-equipped sealing device according to a fifth embodiment of the present invention is now described.

In the encoder-equipped sealing device shown in FIG. 5, the seal element 3 includes a recess 4f that is formed on the side of the flange portion 31b opposite the side on which the seal portion 6 is located. The said recess 4f extends toward the side on which the seal portion 6 is located. That is to say, the recess 4f is formed at the left side of flange portion 31b in FIG. 4. And the recess 4f extends toward the right side in FIG. 4.

When two units 51, 52 of the encoder-equipped sealing device are placed one over the other adjacently to each other so that they are oriented in one particular direction, as shown in FIG. 1, the presence of the recess 4f can keep the area of contact between the encoder 1 in one unit 51 and the flange portion 31b in the other unit 52 as small as possible. This can reduce the magnetic force attracting two units 51 and 52, and can thus prevent the two units from attracting each other magnetically. This recess 4f may be formed by using the knurling process, for example.

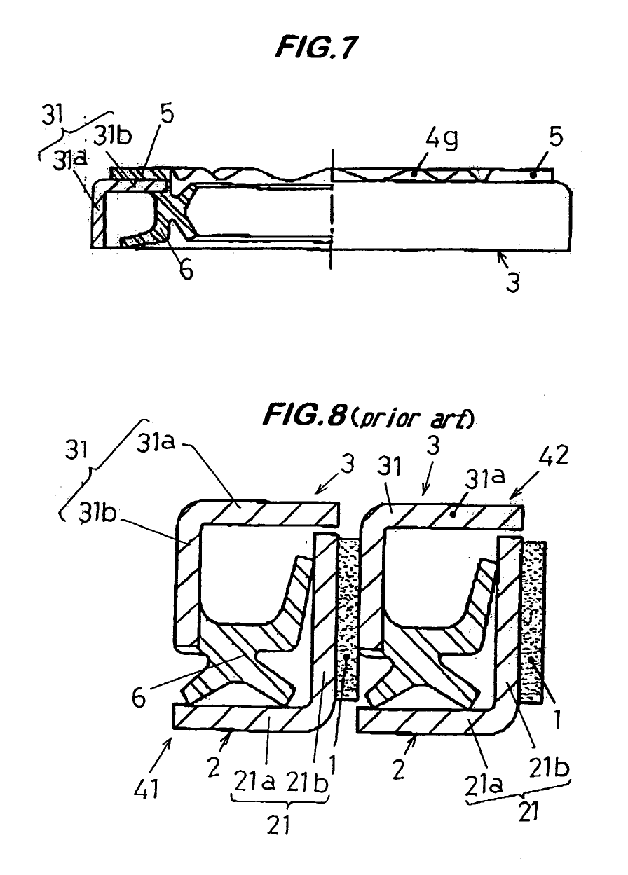

Referring next to FIG. 7, the encoder-equipped sealing device according to a seventh embodiment of the present invention is described.

In the encoder-equipped sealing device shown in FIG. 7, the seal element 3 includes an elastic lateral side portion 5 formed on the side of the flange portion 31b opposite the side on which the seal portion 6 is located. The elastic lateral side portion 5 has undulations 4g formed thereon. This elastic lateral side portion 5 may be made of any elastic materials, such as synthetic rubber, and synthetic resin and the like.

When two units 51, 52 of the encoder-equipped sealing device are placed one over the other adjacently to each other so that they are oriented in one particular direction, as shown in FIG. 1, the elastic lateral side portion 5 having the undulations 4g thereon can keep the gap between the two units 51 and 52 constant, thereby preventing the cohesion by the magnetic attraction that might occur between the two units 51 and 52.

In the embodiment shown in FIG. 7, it should be noted that the elastic lateral side portion 5 having the undulations 4g thereon exists between the encoder 1 in one unit 51 and the metal flange portion 31b in the other unit 52 that is located adjacently to the unit 51. The elastic lateral side portion 5 can keep the encoder 1 in the one unit 51 in soft contact with the metal flange portion 31b in the other unit 52, which will prevent the encoder 1 from being deformed or having the high molecular cohesion with the metal flange portion 31b.

In each of the embodiments shown in FIGS. 1 through 7, it should be noted that the seal portion 6 includes radial lips 6a, 6b extending from the side, at which cylindrical portion 31a exists, toward the forward end of the flange portion 31b and in the direction in which the cylindrical portion 31a extends, so that extending obliquely, and a side lip 6c extending from the forward end of the flange portion 31b toward the cylindrical portion 31a and in the direction in which the cylindrical portion 31a extends, so that extending obliquely.

It should also be noted that when the seal element 3 and seal element 2 are combined such that the space defined by the cylindrical portion 31a and flange portion 31b of the seal element 3 and the space defined by the cylindrical portion 21a and flange portion 21b of the seal element 2 can face opposite each other, the radial lips 6a, 6b can abut the circumferential surface of the cylindrical portion 21a, and the side lip 6c can abut the inner surface of the flange portion 21b.

The seal portion 6 may be made of any elastic materials such as synthetic rubber, synthetic resin and the like, as it is known to the art. It should be understood that the present invention is not limited to the embodiments of the seal portion 6 described above by referring to FIGS. 1 through 7.

The encoder-equipped sealing device of the present invention are used by mounting it on the bearing unit of an automotive vehicle, which comprises an inner race and outer race relatively rotating each other, for example.

In, each of the embodiments described so far by referring to FIGS. 1 through 7, it is assumed that the seal element 2 in the encoder-equipped sealing device 51 is mounted on the rotational element on an automotive vehicle. For example, the encoder-equipped sealing device according to each of those embodiments has been described, assuming that the encoder-equipped sealing device is mounted on the bearing unit with mounting the seal element 2 in the encoder-equipped sealing device 51 on the rotational element, such as inner race. It should be understood, however, the encoder-equipped sealing device according to each of the embodiments described and shown can be mounted on the bearing unit, comprising an inner race and outer race relatively rotating each other, with mounting the seal element 2 in the encoder-equipped sealing device 51 on the outer race, which is a rotational element, although this is not shown.

Although the present invention has been described with reference to several particular preferred embodiments thereof by referring to the accompanying drawings, it should be understood that the present invention is not limited to those embodiments, and various changes and modifications may be made without departing from the spirit and scope of the invention as defined in the appended claims.

What is claimed is:

1. An encoder-equipped sealing device comprising a combination of seal elements (3, 2) each formed from an annular metal core (31, 32) having a substantially L-shaped cross section, each of the annular metal cores (31, 32) having a cylindrical portion (31a, 21a) and a flange portion (31b, 21b) provided on one end of the cylindrical portion (31a, 21a) and extending in the direction perpendicular to the direction in which the cylindrical portion (31a, 21a) extends, wherein
one seal element (3) of the seal elements (3, 2) and the other seal element (2) are combined such that the space defined by the cylindrical portion (31a) and flange portion (31b) of the seal element (3) and the space defined by the cylindrical portion (21a) and flange portion (21b) of the other seal element (2) face opposite each other;
one seal element (3) includes a seal portion (6) made of an elastic element provided on the flange portion (31b) and arranged in the space defined by the cylindrical portion (31a) and flange portion (31b); and
the other seal element (2) includes a magnet-based encoder (1) provided on the flange portion (21b), and wherein
one seal element (3) further includes a projecting portion (4a) provided on the end of the cylindrical portion (31b) on the side on which the flange portion (31b) is located, the projecting portion (4a) extending beyond the side of the flange portion (31b) opposite the side on which the seal portion (6) is located and in the direction in which the cylindrical portion (31a) extends.

2. The encoder-equipped sealing device as defined in claim 1, wherein one seal element (3) includes an end (4b) at the end of the cylindrical portion (31a) on which the flange portion (31b) is located, and wherein said end (4b) forming a projecting portion is formed by folding the base end of the flange portion (31b) and the end of the cylindrical portion (31a) thereby overlapping each other in the direction in which the cylindrical portion (31a) extends.

3. An encoder-equipped sealing device comprising a combination of seal elements (3, 2) each formed from an annular metal core (31, 32) having a substantially L-shaped cross section, each of the annular metal cores (31, 32) having a cylindrical portion (31a, 21a) and a flange portion (31b, 21b) provided on one end of the cylindrical portion (31a, 21a) and extending in the direction perpendicular to the direction in which the cylindrical portion (31a, 21a) extends, wherein
one seal element (3) of the seal elements (3, 2) and the other seal element (2) are combined such that the space defined by the cylindrical portion (31a) and flange portion (31b) of the seal element (3) and the space defined by the cylindrical portion (21a) and flange portion (21b) of the other seal element (2) face opposite each other;
one seal element (3) includes a seal portion (6) made of an elastic element provided on the flange portion (31b) and arranged in the space defined by the cylindrical portion (31a) and flange portion (31b); and
the other seal element (2) includes a magnet-based encoder (1) provided on the flange portion (21b), and wherein
one seal element (3) further includes a projecting portion (4c) extending beyond the side of the flange portion (31b) opposite the side on which the seal portion (6) is located and extending in the direction in which the cylindrical portion (31a) extends.

4. An encoder-equipped sealing device comprising a combination of seal elements (3, 2) each formed from an annular metal core (31, 32) having a substantially L-shaped cross section, each of the annular metal cores (31, 32) having a cylindrical portion (31a, 21a) and a flange portion (31b, 21b) provided on one end of the cylindrical portion (31a, 21a) and extending in the direction perpendicular to the direction in which the cylindrical portion (31a, 21a) extends, wherein
one seal element (3) of the seal elements (3, 2) and the other seal element (2) are combined such that the space defined by the cylindrical portion (31a) and flange portion (31b) of the seal element (3) and the space defined by the cylindrical portion (21a) and flange portion (21b) of the other seal element (2) face opposite each other;
one seal element (3) includes a seal portion (6) made of an elastic element provided on the flange portion (31b) and arranged in the space defined by the cylindrical portion (31a) and flange portion (31b); and
the other seal element (2) includes a magnet-based encoder (1) provided on the flange portion (21b), and wherein
the end portion (4d) of the cylindrical portion (31a) of the seal element (3) extending toward the other seal element (2) is extending in the direction in which the cylindrical portion (31a) extends and beyond the side of the other seal; element (2) opposite the side on which the other seal element (2) faces opposite the seal element (3).

5. An encoder-equipped sealing device comprising a combination of seal elements (3, 2) each formed from an annular metal core (31, 32) having a substantially L-shaped cross section, each of the annular metal cores (31, 32) having a cylindrical portion (31a, 21a) and a flange portion (31b, 21b) provided on one end of the cylindrical portion (31a, 21a) and extending in the direction perpendicular to the direction in which the cylindrical portion (31a, 21a) extends, wherein
one seal element (3) of the seal elements (3, 2) and the other seal element (2) are combined such that the space defined by the cylindrical portion (31a) and flange portion (31b) of the seal element (3) and the space defined by the cylindrical portion (21a) and flange portion (21b) of the other seal element (2) face opposite each other;
one seal element (3) includes a seal portion (6) made of an elastic element provided in the flange portion (31b) and arranged in the space defined by the cylindrical portion (31a) and flange portion (31b); and
the other seal element (2) includes a magnet-based encoder (1) provided on the flange portion (21b), and wherein
one seal element (3) further includes a recess (4f) formed on the side of the flange portion (31b) opposite the side on which the seal portion (6) is located and extending toward the side on which the seal portion (6) is located.

6. An encoder-equipped sealing device comprising a combination of seal elements (3, 2) each formed from an annular metal core (31, 32) having a substantially L-shaped cross section, each of the annular metal cores (31, 32) having a cylindrical portion (31a, 21a) and a flange portion (31b, 21b) provided on one end of the cylindrical portion (31a, 21a) and extending in the direction perpendicular to the direction in which the cylindrical portion (31a, 21a) extent, wherein
one seal element (3) of the seal elements (3, 2) and the other seal element (2) are combined such that the space defined by the cylindrical portion (31a) and flange portion (31b) of the seal element (3) and the space defined by the cylindrical portion (21a) and flange portion (21b) of the other seal element (2) face opposite each other;
one seal element (3) includes a seal portion (6) made of an elastic element provided on the flange portion (31b) and arranged in the space defined by the cylindrical portion (31a) and flange portion (31b); and
the other seal element (2) includes a magnet-based encoder (1) provided on the flange portion (21b), and wherein
the encoder (1) is arranged on the side of the flange portion (21b) opposite the side on which the flange portion (21b) faces opposite the one seal element (3) and
the flange portion (21b) includes a projecting portion (4e) extending beyond the surface of the encoder (1) and in the direction in which the cylindrical portion (21a) extends.

7. An encoder-equipped sealing device comprising a combination of seal elements (3, 2) each formed from an annular metal core (31, 32) having a substantially L-shaped cross section, each of the annular metal cores (31, 32) having a cylindrical portion (31a, 21a) and a flange portion (31b, 21b) provided on one end of the cylindrical portion (31a, 21a) and extending in the direction perpendicular to the direction in which the cylindrical portion (31a, 21a) extends, wherein
one seal element (3) of the seal elements (3, 2) and the other seal element (2) are combined such that the space defined by the cylindrical portion (31a) and flange portion (31b) of the seal element (3) and the space defined by the cylindrical portion (21a) and flange portion (21b) of the other seal element (2) face opposite each other;
one seal element (3) includes a seal portion (6) made of an elastic element provided on the flange portion (31b) and arranged in the space defined by the cylindrical portion (31a) and flange portion (31b); and
the other seal element (2) includes a magnet-based encoder (1) provided on the flange portion (21b), and wherein
one seal element (3) further includes an elastic lateral side portion (5) formed on the side of the flange portion (31b) opposite the side on which the seal portion (6) is located, the elastic lateral side portion (5) having undulations (4g) formed thereon.
